(19) United States
(12) Patent Application Publication
(10) Pub. No.: US 2016/0186957 A1
(43) Pub. Date: Jun. 30, 2016

(54) COOLING DEVICE FOR A HEADLIGHT OF A MOTOR VEHICLE, IN PARTICULAR FOR A LASER HEADLIGHT

(71) Applicant: ZIZALA LICHTSYSTEME GMBH, Wieselburg (AT)

(72) Inventors: Burkhard LEWERICH, München (DE); Adrian NOREK, Poznan (PL); Alexander POCHE, St. Georgen am Ybbsfelde (AT); Matthias FUCHS, München (DE)

(21) Appl. No.: 14/912,359

(22) PCT Filed: Aug. 13, 2014
(86) PCT No.: PCT/EP2014/067346

§ 371 Date: Feb. 16, 2016

(30) Foreign Application Priority Data
Aug. 23, 2013 (DE) 102013216869.1

(51) Int. Cl. F21S 8/10

(52) U.S. Cl. CPC F21S 48/328; F21S 48/1145; F21S 48/1233

(57) ABSTRACT

The invention relates to a cooling device for a headlight of a motor vehicle, in particular for a laser headlight. The cooling device comprises a cooling body for thermal contacting a light source of the headlight and one or more passive air guides. A respective air guide comprises an inlet conduit and an outlet conduit so that, while the motor vehicle is moving, outside air from outside the headlight is fed to the cooling body via the inlet conduit and the outside air is discharged again via the outlet conduit. The outside air enters the inlet conduit via an inlet opening and exits the outlet conduit via an outlet opening, both openings positioned remotely from the cooling body. The cooling device may be positioned in the motor vehicle such that, while the motor vehicle is moving, the air pressure at the inlet opening is higher than the air pressure at the outlet opening.

The invention relates to a cooling device for a headlight of a motor vehicle, in particular for a laser headlight.

Due to the advancements in light technology for motor vehicle headlights, the requirements with regard to suitable cooling of installed light sources are becoming ever more stringent. In particular, when using laser light, there it the problem that the laser diodes contained in the laser light source have an operating temperature of typically only up to 70° C. which lies significantly below the operating temperature of LED light sources, which operate in the range of 100° C. Therefore, when cooling laser headlights, active cooling systems are required, such as Peltier elements or cooling fans. This makes cooling very expensive and in addition requires electric power.

It is therefore an object of the invention to provide a cooling device for a motor vehicle headlight which ensures simple and efficient passive cooling.

This object is solved by a cooling device according to patent claim 1. Preferred embodiments of the invention are defined in the dependent claims.

The cooling device according to the invention comprises a (passive) cooling body for thermal contacting a light source and in particular a laser light source of a motor vehicle headlight as well as one or more passive air guides (i.e. air guides without fan). The headlight is preferably a front headlight. A respective air guide includes an inlet conduit and an outlet conduit so that, while the motor vehicle is moving, outside air from outside the headlight is fed to the cooling body via the inlet conduit and the outside air is discharged again via the outlet conduit. Thus, cooling is achieved by using ambient air from outside the motor vehicle as a cooling means. The outside air enters the inlet conduit via an inlet opening positioned remotely from the cooling body. Similarly, the exit of the outside air from the outlet conduit takes place via an outlet opening also positioned remotely from the cooling body. The inlet opening/the outlet opening thus represents the end of the inlet conduit/the outlet conduit, which lies opposite the end of the inlet conduit/the outlet conduit positioned adjacently to the cooling body. The cooling device according to the invention is configured to be positioned in the motor vehicle such that, while the vehicle is moving, the air pressure at the inlet opening is higher than the air pressure at the outlet opening.

Where in the following, and in particular in the patent claims, interactions are described between the cooling device and the components of the motor vehicle, this is always to be understood such that the interaction occurs when the cooling device is positioned/installed in the motor vehicle. The components of the cooling device which interact with the motor vehicle/components of the motor vehicle, are therefore configured such that the interaction is generated when the cooling device is positioned/installed in the motor vehicle.

The cooling device according to the invention has the advantage that a suitable cooling air flow for a cooling body can passively be generated solely via an existing pressure difference between the inlet opening and the outlet opening of an air guide.

Efficient cooling can thus be achieved in a simple manner without active components. This cooling is sufficient for a laser light source in a motor vehicle headlight.

In a particularly preferred embodiment, the inlet opening and the outlet opening for at least one air guide of the cooling device are provided in a wall of an air duct of the motor vehicle, in which air duct, while the motor vehicle is moving, an air flow is generated, wherein the air duct interacts with the inlet opening and the outlet opening such that, while the motor vehicle is moving, the air pressure at the inlet opening is higher than the air pressure at the outlet opening. The air duct may, for example, be a brake air duct in the motor vehicle or an air duct for improving the aerodynamics of the motor vehicle. The arrangement of the inlet opening and the outlet opening in an air duct has the advantage of avoiding contamination of these openings caused by heavy dirt particles from outside the vehicle.

In a particularly preferred embodiment, a profile element is arranged between the inlet opening and the outlet opening in a wall portion of the air duct, the profile element, while the motor vehicle is moving, causing an air flow which is faster at the outlet opening than at the inlet opening. This faster air flow at the outlet opening results in a pressure lower than the pressure present at the inlet opening. The wall portion just defined may be part of the cooling device, wherein the wall portion is inserted into a correspondingly opened area of the air duct, when the cooling device is being installed in the motor vehicle.

Preferably, the profile element causes a narrowing of the air flow in the air duct in the area of the outlet opening. In particular, this narrowing is greater than a narrowing (if any) in the area of the inlet opening of the air duct. As a result, the velocity of the flow at the outlet opening is increased and the air pressure is reduced. Alternatively or additionally, the profile element may cause a throttling of the air flow in the direction of the air flow behind the inlet opening. As a result, the velocity of the air flow at the inlet opening is decreased and the air pressure is increased. The embodiment of the profile element just described therefore increases the pressure difference between the inlet opening and the outlet opening, thereby improving the suction effect.

Preferably, the inlet opening and the outlet opening are arranged offset relative to one another in a direction perpendicular to the air flow in the air duct, wherein the profile element is an elongated element and extends in its longitudinal direction between the inlet opening and the outlet opening. Where appropriate, the inlet opening and outlet opening may also be offset from one another in direction of the air flow. In order to achieve the pressure difference between the inlet opening and the outlet opening, the profile element is preferably ramp-shaped or wave-shaped or shaped as an aerofoil.

In another preferred embodiment, an inner curvature is provided in a wall portion of the air duct, the inner curvature being positioned in direction of the air flow directly ahead of the inlet opening. The wall portion with the inner curvature may again be part of the cooling device and may be inserted into an opening in the air duct. The inner curvature causes an increase in the velocity of the air flow at the outlet opening and thereby a lower pressure.

In another particularly preferred embodiment, the inlet opening and the outlet opening are arranged in an essentially vertically extending side wall of the air duct. This has the effect to avoid very efficiently the intrusion of dirt particles into the openings.

In another embodiment of the cooling device according to the invention, a grid, in particular a lamella grid, is provided for at least one air guide at the inlet opening and/or the outlet opening. This is another protective measure against the intrusion of dirt particles into the openings. Furthermore, the grid also serves as a protection against crawling insects. In another embodiment of the cooling device according to the invention, the inlet opening for at least one air guide is arranged in the front of the motor vehicle, in particular at the bumper. In this area, the deceleration of the oncoming flow to the moving motor vehicle is very strong, thereby creating a particularly high pressure.

In another variant, the outlet opening for at least one air guide is arranged in the lateral area of the motor vehicle, in particular in the wheel housing of the motor vehicle. Alternatively, the outlet opening may be arranged in the underfloor of the motor vehicle, preferably behind a ram air lip or in the suction area of a radiator fan of the motor vehicle or in an air duct of the motor vehicle. In this arrangement, the air duct may correspond to the above-described air duct and as such may be, for example, the brake air duct or an air duct for improving the aerodynamics of the motor vehicle. The areas just described, in which the outlet opening may be arranged, are areas with low air pressure while the motor vehicle is moving.

In another variant, the headlight to be cooled by the cooling device comprises a lens for light emission, which extends from the front area into the lateral area of the motor vehicle, wherein for at least one air guide the inlet opening is provided in the lens in the front area and the outline opening is provided in the lens in the lateral area. In this way, the air guide can be accommodated completely in the installation space of the headlight, and there are no interfaces which need to be considered for an assembly to other modules. Assembly and removal of the cooling device is thereby simplified.

In another variant, the part of the cooling body to which the outside air is being fed, is arranged outside the housing of the cooling body. Furthermore, the cooling body preferably comprises a plurality of ribs and/or lamellae and/or pins, around which the outside air flows, thereby achieving good cooling.

In addition to the above-described cooling device, the invention also relates to a motor vehicle which comprises a number of headlights, wherein the cooling device according to the invention/one or more preferred variants of the cooling device according to the invention is provided respectively for one or more of the headlights.

Embodiments of the invention will now be described with reference to the accompanying drawings, in which:

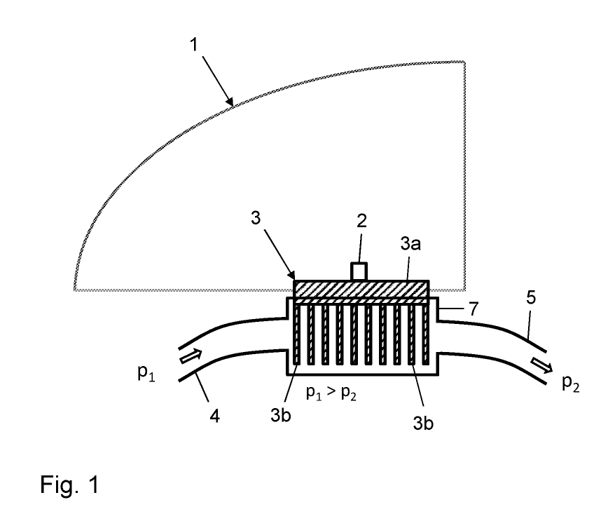

FIG. 1 is a schematic illustration of the principle of the cooling device according to the invention;

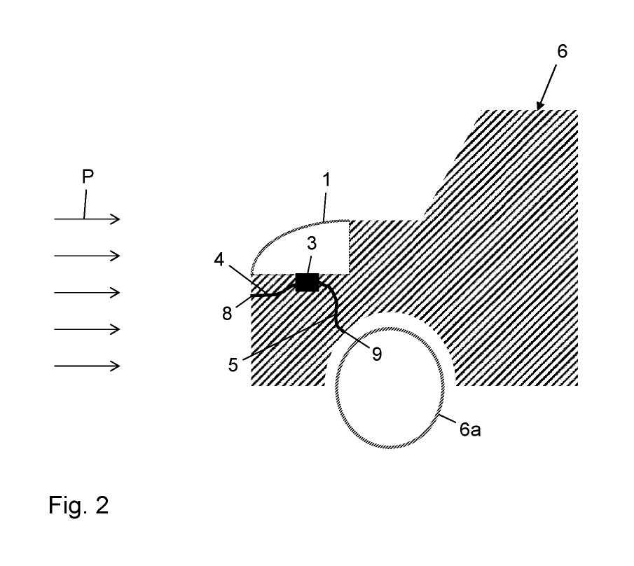

FIG. 2 is a schematic illustration of a first embodiment of a cooling device according to the invention installed in a motor vehicle;

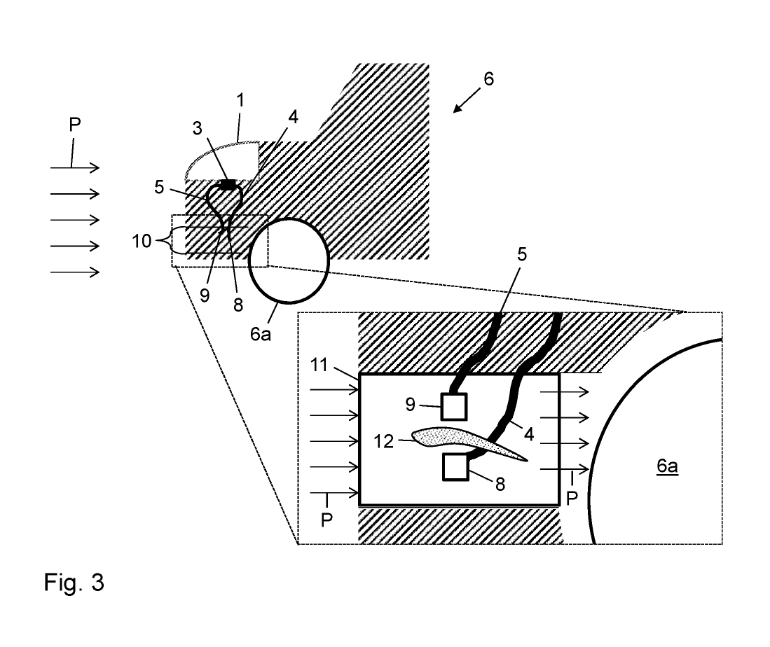

FIG. 3 is a schematic illustration of a second embodiment of a cooling device according to the invention installed in a motor vehicle;

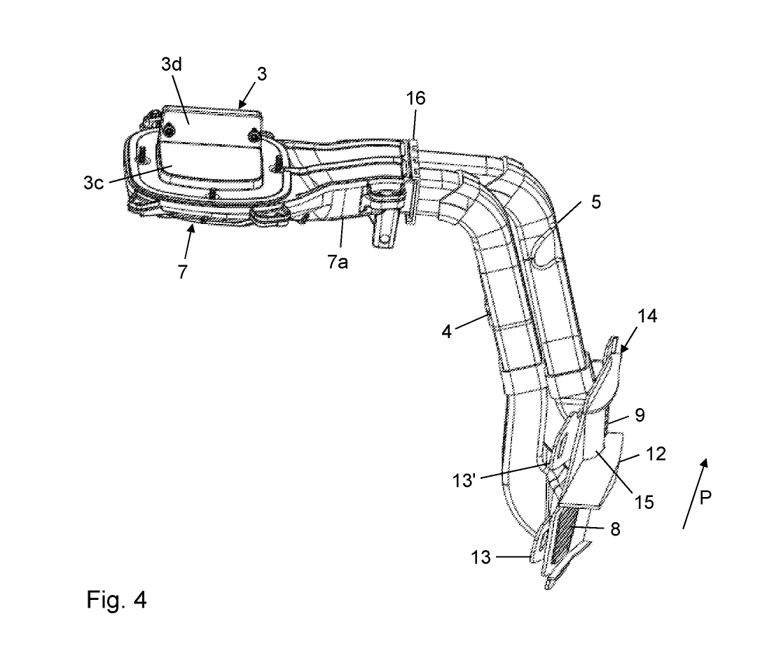

FIG. 4 is a perspective view of a variant of the cooling device shown in FIG. 3;

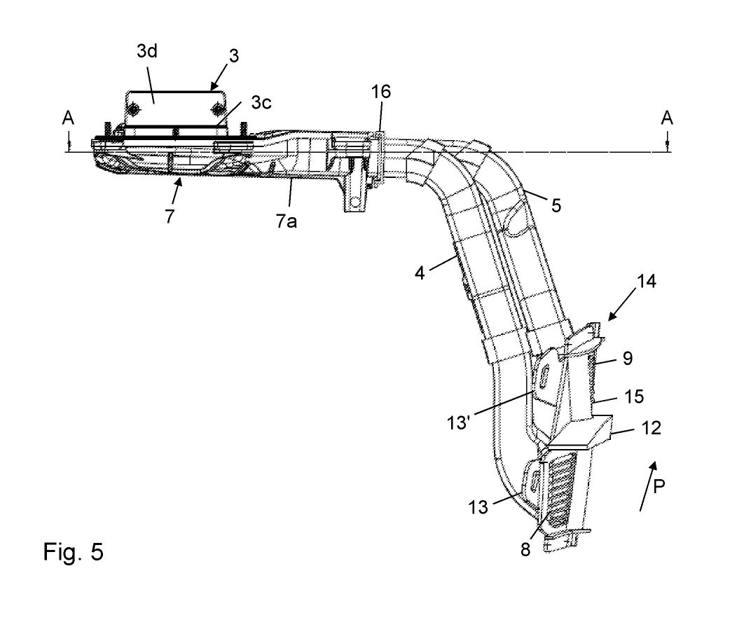

FIG. 5 is a side view of the cooling device shown in FIG. 4;

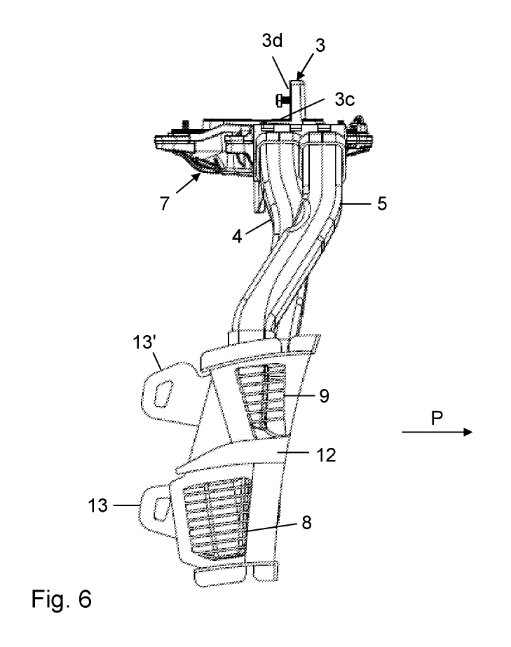

FIG. 6 is a front view of the cooling device shown in FIG. 4; and

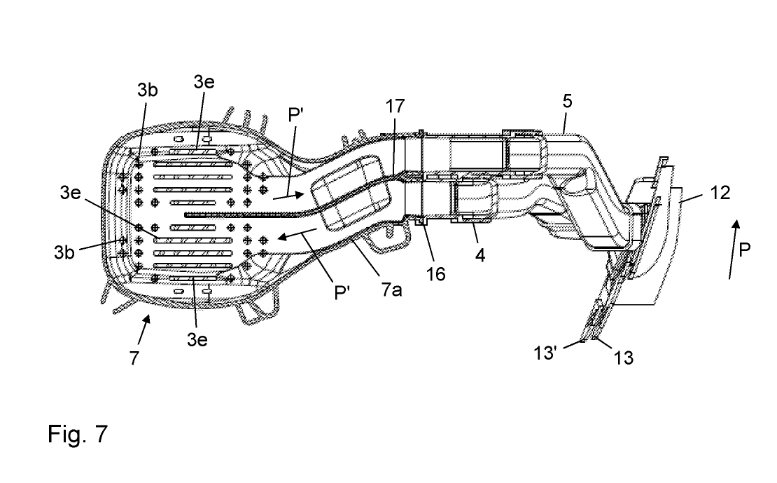

FIG. 7 is a sectional view along line A-A of the cooling device shown in FIG. 5.

The below-described embodiments of the invention are described with reference to the cooling of a front headlight of a motor vehicle, wherein the headlight, for generating the light distribution on the road, contains a laser module with one or more laser diodes, as required. In contrast to conventional LED headlights, the demand for cooling is therefore increased, because laser diodes are restricted to being operated at ambient temperatures up to merely approx. 70° C., whereas LEDs have an operating range up to approx. 100° C. In order to ensure an adequate cooling of laser diodes, embodiments of cooling devices will now be described which generate an outside air flow in a simple way without the use of a fan. By this air flow, a corresponding cooling body, which is thermally connected to the laser light source, can be adequately cooled.

FIG. 1 schematically shows a side view of a front headlight 1. In the front headlight, a schematically drawn laser diode 2 is provided as a light source, which generates monochromatic light, which is preferably guided via a fibre (not shown) to a secondary optics, which then generates the desired light distribution on the road. At the fibre end positioned remotely from the laser diode, a conversion element is provided which converts the monochromatic light of the laser diode into white light. According to FIG. 1, the laser diode 2 is thermally connected to the top of the cooling body 3, which is a metallic body formed in the upper area as a solid body 3a. On the underside of the solid body, a plurality of pins 3b are provided, only some of which are marked with this reference numeral. The lower part of the cooling body is arranged in a housing 7 outside the headlight 1. This housing has an inlet conduit/an inlet tube 4 as well as an outlet conduit/an outlet tube 5 connected to it.

The principle of the cooling device according to the invention is based on the idea that the inlet opening of the inlet tube (not shown in FIG. 1) and the outlet opening of the outlet tube (not shown in FIG. 1) are arranged in the motor vehicle in such a way that the pressure present at the inlet opening is higher than the pressure present at the outlet opening. The pressure at the inlet opening is marked in FIG. 1 with p₁ and the pressure at the outlet opening is marked with p₂. Based on this pressure difference, a suction effect without active cooling is created. Based on this suction effect, an air flow is generated from the inlet tube 4 via the housing 7 to the outlet tube 5, as indicated in FIG. 1 by two arrows.

FIG. 2 shows a schematic view which indicates a possible arrangement of the inlet tube 4 and the outlet tube 5 in a motor vehicle. In FIG. 2, the motor vehicle is schematically indicated by reference numeral 6 and its front wheel is indicated by reference numeral 6a. The oncoming flow to the moving motor vehicle is illustrated by arrows, wherein for reasons of clarity only one arrow is marked with the reference numeral P. As can be seen in FIG. 2, the inlet tube 5 extends from the cooling body 3 to a front end 8, which forms the inlet opening. This end is provided in an area with high air pressure at the bumper at the front of the vehicle. The high pressure is created due to strong deceleration of the oncoming flow at the front of the vehicle.

Depending on the embodiment, the inlet opening 8 may be provided at different positions at the front of the vehicle. In one variant, it is arranged at the stagnation point of the flow in the centre of the front. It is also possible to form the inlet opening e.g. by a gap between the bumper and the lens of the headlight 1.

In contrast to the inlet opening, the outlet opening 9 is arranged at the rear end of the outlet tube 5 in an area with low air pressure compared to the inlet opening. In FIG. 2, the outlet opening 9 is located in the wheel housing of the vehicle wheel 6a. Further possible locations for the outlet opening are the suction area of the radiator fan in the vehicle because the pressure conditions are lower in this area. Furthermore, the outlet opening 9 may e.g. be arranged in an air duct, such as in the brake air duct or in an air duct provided for aerodynamic purposes (also known as an air curtain duct).

One can also think of other ways of arranging the inlet opening 8 and the outlet opening 9. However, it must be ensured that the pressure at the outlet opening 9 is lower than at the inlet opening 8 so that, due to the drop in pressure, the air automatically flows from the inlet opening via the cooling body to the outlet opening. In a motor vehicle, where the headlight/its lens extends from the front of the vehicle into its lateral area, the inlet opening may, for example, be an opening in the front area of the lens, whereas the outlet opening is formed in the lateral area of the lens. Inbetween those areas the cooling body is located which is connected via an inlet tube/an outlet tube to the inlet opening/the outlet opening.

FIG. 3 shows a particularly preferred variant of the arrangement of the inlet opening of the inlet tube and the outlet opening of the outlet tube. In contrast to FIG. 1 and FIG. 2, the inlet tube is now connected to the rear part of the cooling body 3, whereas the outlet tube is connected in the front part of the cooling body. In FIG. 3, both inlet tube and outlet tube lead into an air duct 10, which is provided in the vehicle for aerodynamic purposes. This air duct is arranged on the right-hand and left-hand side of the vehicle and extends from the front of the vehicle to the wheel housing. In FIG. 3, the air duct is shown on the left-hand side of the vehicle. While the vehicle is moving, the air flow flowing through the duct improves the aerodynamics of the vehicle. Analogously to FIG. 2, the oncoming flow to the moving vehicle and also the air flow through the duct are indicated by arrows, marked partly with the reference numeral P. As revealed in the detail view in FIG. 3, the inlet opening 8 and the outlet opening 9 are arranged on the inner side wall 11 of the duct 10, the inlet opening 8 lying below the outlet opening 9.

In order to generate an air pressure difference between the inlet opening and the outlet opening in the embodiment of FIG. 3, a profile element 12 in the form of an airfoil profile is provided between the inlet opening and the outlet opening. The profile element extends from the side wall 11 into the interior of the duct 10. The arrangement and alignment of the airfoil profile 12 is such that, in the area of the two openings 8 and 9, the air flow at the outlet opening 9 is narrowed more than at the inlet opening 8. Furthermore, the form of the airfoil profile towards its rear end is such that the space towards the bottom of the duct on the side of the inlet opening 8 is less than the space towards the top of the duct on the side of the outlet opening 9. As a result, a throttling effect is generated. Due to this throttling effect and the increased narrowing of the duct in the area of the outlet opening 9, the air flow at the inlet opening 8 flows at a lower speed than at the outlet opening 9. The lower speed of the air flow leads to an air pressure at the inlet opening 8, which is higher than at the outlet opening 9. Therefore, a pressure difference is created by the profile element 12. This pressure difference has the effect that air flows from the inlet opening 8 to the outlet opening 9.

FIG. 4 to FIG. 7 show different views of a cooling device which is based on the principle shown in FIG. 3. Therefore, in the following Figures, the same reference numerals are used for denoting the same components as in FIG. 3. Once again, the air flow in the motor vehicle is indicated by an arrow P. In the following, only those components of the cooling device are described, which are essential to the invention. According to the variant shown in FIG. 4, the cooling device comprises two tubes 4 and 5. At the lower end of the tubes there is a wall portion 14, which, when the cooling device is installed in the motor vehicle, forms part of the side wall 11, which is inserted into a correspondingly opened area of the air duct 10 and is attached there to in a suitable manner via eyelets 13 and 13′. In this wall portion, analogously to FIG. 3, an inlet opening 8 and an outlet opening 9 above the inlet opening are provided which are each connected to the inlet conduit 4/the outlet conduit 5. Both openings are provided with a lamella grid as a protection against contamination/the intrusion of larger dirt particles into the cooling air flow.

A profile element 12 is once again provided between the inlet opening 8 and the outlet opening 9, which compared to the embodiment shown in FIG. 3 is shaped as a ramp, as more clearly revealed in FIG. 5 and FIG. 6. Moreover, an inner curvature is provided in the wall portion 14 above the profile element directly ahead of the outlet opening 9. This has the effect of further constricting the air flow in the area of the outlet opening 9 and thus accelerating the same, thereby further reducing the pressure at the outlet opening and thus improving the air flow in the tubes 4 and 5.

The inlet and outlet tubes 4 and 5, at the upper ends thereof, terminate in a flange 16 in a rear portion 7a of a housing/a cooling body cover 7. The lower part of the cooling body 3 lies in the front part of the housing. The cover 7 is attached to the housing underside of the headlight to be cooled so that the top 3c of the cooling body 3 lies inside the headlight housing. Above this top and spaced apart therefrom, the laser light source (not shown) is arranged in the form of a pump module. The laser light source is screwed to a vertically extending flange 3d of the cooling body 3. In this way a thermal contact is established between the cooling body and the laser light source. As explained in more detail further below, cooling air passes through the lower part of the cooling body inside the housing 7, wherein this air flows from the air duct through the inlet conduit 4 to the cooling body. Thereform, the air is guided through the outlet conduit 5 back into the air duct.

FIG. 5 shows a side view of the cooling device shown in FIG. 4. FIG. 5 reveals the shape of the profile element 12. In particular, it can be seen that the profile element is shaped in the manner of a wedge, the topside of which extends initially more steeply in the direction of the air flow and then flattens towards the rear. The shape of the profile element is revealed even more clearly in the top view of FIG. 6. This Figure also shows that the inlet opening 8 is slightly offset from the outlet opening 9. In addition, one can see that, due to the wedge-shaped/ramp-shaped profile element, the area of the air flow at the outlet opening 9 is narrower than at the inlet opening 8, with the result that the flow is faster at the outlet opening 9 and the pressure is thus lower at this point than at the inlet opening 8 so that the air flow is generated from the inlet opening towards the outlet opening.

FIG. 7 shows a sectional view along line A-A of the cooling device shown in FIG. 5. The structure of the cooling body inside the housing 7 can be seen in this Figure. In particular, it can be seen that the cooling body, apart from the downwardly extending cooling pins 3b, comprises a plurality of cooling lamellae 3e. For reasons of clarity, only some of the pins and lamellae are marked by these reference numerals. The housing 7 further includes a partition wall 17, by which the air flow coming from the inlet tube 4 is separated from the air flow towards the outlet tube 5, up to shortly before the front end of the housing. This has the effect that the outside air flows well around the pins and lamellae of the cooling body, where the direction of the flow in the housing is indicated by the two arrows P′. Thus, cooling of the cooling body is achieved solely by the outside air from outside the headlight housing.

The embodiments of the invention described in the foregoing have a number of advantages. In particular, it is possible to achieve a cooling air flow by a suitable arrangement of an inlet opening and an outlet opening of corresponding cooling conduits in the motor vehicle. The openings are positioned such that, while the vehicle is moving, an air pressure difference occurs between the inlet opening and the outlet opening, which leads to a suction effect and thus to a cooling air flow, without this flow having to be generated actively, e.g. by means of a fan.

In a particularly preferred variant, the inlet opening and the outlet opening are positioned in the same air duct, wherein the air pressure difference is generated as a result of a modification of the air duct via a profile element. This variant has the advantage that the risk of contamination of the cooling air guide is reduced. The cooling air is branched off transversely to the direction of the main flow in the air duct, so that heavy dirt particles, such as snow or pollutants, cannot contaminate the inlet and outlet openings. Fine dust following the flow is not a problem since it leaves the cooling air guide again at the outlet.

The cooling air guide according to the invention can achieve sufficient cooling even for headlights with laser diodes. The cooling device is cost-effective and robust. Moreover, no electric power is needed because it works purely passively and therefore without any need for active components such as a fan or a Peltier element.

### LIST OF REFERENCE NUMERALS

1 headlight

2 laser diode

3 cooling body

3a solid body

3b pins

3c top of the cooling body

3d flange

3e lamellae

4 inlet conduit

5 outlet conduit

6 motor vehicle

7 housing

7a rear housing portion

8 inlet opening

9 outlet opening

10 air duct

11 side wall

12 profile element

13, 13′ eyelets

14 wall portion

15 inner curvature

16 flange

17 partition wall

1. A cooling device for a headlight of a motor vehicle, in particular for a laser headlight, wherein the cooling device comprises a cooling body for thermal contacting a light source of the headlight and one or more passive air guides;
wherein a respective air guide comprises an inlet conduit and an outlet conduit so that, while the motor vehicle is moving, outside air from outside the headlight is fed to the cooling body via the inlet conduit and the outside air is discharged again via the outlet conduit ;
wherein the outside air enters the inlet conduit via an inlet opening positioned remotely from the cooling body and exits the outlet conduit via an outlet opening positioned remotely from the cooling body;
wherein the cooling device is configured to be positioned in the motor vehicle such that, while the motor vehicle is moving, the air pressure at the inlet opening is higher than the air pressure at the outlet opening.

2. The cooling device according to claim 1, wherein; for at least one air guide the inlet opening and the outlet opening are provided in a wall of an air duct of the motor vehicle, in which air duct, while the motor vehicle is moving, an air flow is generated, wherein the air duct interacts with the inlet opening and the outlet opening such that, while the motor vehicle is moving, the air pressure at the inlet opening is higher than the air pressure at the outlet opening.

3. The cooling device according to claim 2, wherein a profile element is arranged between the inlet opening and the outlet opening in a wall portion of the air duct, the profile element, while the motor vehicle is moving, causing an air flow which is faster at the outlet opening than at the inlet opening.

4. The cooling device according to claim 3, wherein the profile element causes a narrowing of the air flow in the air duct in the area of the outlet opening and/or a throttling of the air flow in the direction of the air flow behind the inlet opening.

5. The cooling device according to claim 3, that wherein the inlet opening and the outlet opening are offset relative to one another in a direction perpendicular to the air flow in the air duct, wherein the profile element is an elongated element and extends in its longitudinal direction between the inlet opening and the outlet opening.

6. The cooling device according to claim 3, wherein the profile element is ramp-shaped or wave-shaped or is shaped as an aerofoil.

7. The cooling device according to claim 2, wherein an inner curvature is provided in a wall portion of the air duct, the inner curvature being positioned in direction of the air flow directly ahead of the inlet opening.

8. The cooling device according to claim 2, wherein the inlet opening and the outlet opening are arranged in an essentially vertically extending side wall of the air duct.

9. The cooling device according to claim 2, wherein the air duct is a brake air duct in the motor vehicle or an air duct for improving the aerodynamics of the motor vehicle.

10. The cooling device according to claim 1, wherein a grid, in particular a lamella grid, is provided for at least one air guide at the inlet opening and/or the outlet opening.

11. The cooling device according to claim 1, wherein for at least one air guide the inlet opening is arranged in the front of the motor vehicle, in particular at the bumper.

12. The cooling device according to claim 1, wherein for at least one air guide the outlet opening is arranged in the lateral area of the motor vehicle, in particular in the wheel housing of the motor vehicle, or in the underfloor of the motor vehicle, preferably behind a ram air lip, or in the suction area of a radiator fan of the motor vehicle or in an air duct of the motor vehicle.

13. The cooling device according to claim 1, wherein the headlight comprises a lens for the emission of light, which extends from the front area into the lateral area of the motor vehicle, wherein for at least one air guide the inlet opening is provided in the lens in the front area and the outlet opening is provided in the lens in the lateral area.

14. The cooling device according to claim 1, wherein the part of the cooling body to which outside air is being fed, is arranged outside the housing of the headlight and/or in that the cooling body comprises a plurality of ribs and/or lamellae and/or pins, around which the outside air flows.

15. A motor vehicle, comprising a number of headlights, wherein a respective cooling device according to claim 1 is provided for one or more of the headlights.
